(19) United States
(12) Patent Application Publication
(10) Pub. No.: US 2012/0120086 A1
(43) Pub. Date: May 17, 2012

(54) Interactive and Scalable Treemap as a Visualization Service

(75) Inventors: Yingnong Dang, Beijing (CN); Dong Zhuang, Beijing (CN); He Huang, Beijing (CN); Haidong Zhang, Beijing (CN); Dongmei Zhang, Bellevue, WA (US)

(73) Assignee: Microsoft Corporation, Redmond, WA (US)

(21) Appl. No.: 12/947,748

(22) Filed: Nov. 16, 2010

(51) Int. Cl. G09G 5/02

(52) U.S. Cl. 345/589

(57) ABSTRACT

Techniques for providing a visualization of an interactive and scalable treemap are described. A service provider hosts large-scale hierarchical data and supports online users who desire to visualize the large-scale hierarchical data in a treemap format on their computing devices.

The user experience may be enhanced by providing a user interface for visualization of the interactive and scalable treemap. The visualization enables navigation and customization of data in the interactive and scalable treemap. The user experience is further enhanced by illustrating attributes are distinct by displaying a color or a pattern selected for a background or a bar of polygon. The user experience is further enhanced by providing the interactive and scalable treemap to the user on a website or on servers operated by a service or another third party service.

### BACKGROUND

Hierarchical (tree-structured) data may be visualized as nested rectangles in a treemap. Each branch in the tree has a rectangle, which is then tiled with smaller rectangles representing sub-branches. A rectangle of a leaf node has an area that is proportional to a specified dimension on the data, such as varying depth. Treemaps may often be used for space-constrained visualization of the hierarchical data.

However, there are problems visualizing the data in the treemap if the data is large-scale, stored in a server or cloud, updated from time to time, and desired for viewing by multiple users from different machines. The number of nodes of the large-scale hierarchical data may be approximately one to more than 10 million. One problem is the client side machines cannot handle a treemap associated with a large number of nodes due to the hardware constraint. Another problem is the client side machines do not have any type of interaction availability for scaling or interacting in the treemap. Another problem is the client side machines do not offer options for customized views based on needs of different users. Another problem is the client side machines cannot efficiently and timely download updates.

As the demand for the visualization of data continues to grow, there is increasing opportunity to provide an interactive user experience during visualization of large-scale data.

### SUMMARY

This disclosure describes creating an interactive and scalable treemap for visualization as part of an online service. In an implementation, a user interface includes a visualization of nodes for large-scale hierarchical data in a treemap, wherein the nodes are represented by polygons in the treemap. The user interface includes one or more navigation buttons receiving a selection of a color or a pattern for a background of a polygon, where the color or the pattern in the background is used to visualize a first property of the nodes. The one or more navigation buttons further receive another selection of another color or another pattern for a bar in the polygon, where the another color or the another pattern in the bar is used to visualize a second property of the nodes. Next, the one or more navigation buttons receiving a selection of a name of the first property to be placed on top of the selected color or pattern for the bar that is placed over the selected color or pattern for the background of the polygon in presenting the visualization of the treemap.

In another implementation, a process receives input of large-scale hierarchical data with multiple attributes associated with nodes into a treemap, wherein the nodes are represented by polygons in the treemap. The process identifies a size for each of the polygons. Based on a constraint, the size of the polygons is based on a value of a primary attribute of a parent node is equal to a summary of an attribute value of all of its children nodes. In addition, the process provides a visualization of the treemap based on the identified size of the polygons. The process also provides a trending function to enable visualizing trending of an attribute of a node, wherein the node is associated with temporal information over a period of time.

In yet another implementation, a process presents a visualization of large-scale hierarchical data with multiple attributes associated with nodes in a treemap, wherein the nodes are represented by polygons in the treemap. The process receives a query for a search of the polygons using a search function, presents search results in response to the query, assigns a numerical order to each search result in a list, and displays a number that corresponds to the numerical order on a polygon associated with the search results.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 illustrates an illustrative architectural environment for implementing a data visualization service to a user.

FIG. 2 shows an illustrative user interface (UI) provided by the data visualization service.

FIG. 3 shows an illustrative process for receiving input of attributes and receiving input for visualization for a color or a pattern for a background and/or a bar.

FIG. 4 shows another illustrative user interface (UI) for the data visualization service to implement functionalities.

FIG. 5 shows another illustrative user interface (UI) for the data visualization service to implement search functionalities.

FIG. 6 is a flowchart showing illustrative phases for providing the data visualization service for use by the architecture of FIG. 1.

FIG. 7 is a block diagram showing illustrative computing devices to access the data visualization service and illustrative interactive and scalable treemap servers to implement the data visualization service.

FIG. 8 is a block diagram showing an illustrative interactive and scalable treemap server with selected components to implement the data visualization service.

FIG. 9 is a block diagram showing an illustrative computing device with selected components to access the data visualization service.

FIG. 10 is a flowchart showing an illustrative process of receiving input data to generate an interactive and scalable treemap.

FIG. 11 is a flowchart showing an illustrative process of generating layout of data for the interactive and scalable treemap.

FIG. 12 is a flowchart showing an illustrative process of determining layout of children for the interactive and scalable treemap.

### DETAILED DESCRIPTION

### Overview

An online provider may provide a data visualization service to create an interactive and scalable treemap to enhance user experience. The data visualization service hosts large-scale data, and supports online users who desire to visualize the large-scale data in a treemap format on their own computing devices. A user may customize visualizations of the treemap, may scale a large number of information in the treemap, and may share customized information of the treemap with other users.

A user interface pane receives a visualization of a treemap based on a tree-structure. The data in the treemap is organized in a hierarchical order based on the tree-structure having nodes (e.g., branches). The nodes may be represented by a plurality of nested polygons with sub-polygons, where the nodes link the information at the different levels.

The size of the polygon is based on an area that is proportional to a specification of the data. For instance, the attribute is a specification that defines a property of an object, an element, or a file. The attribute may include a name and a value of an object, a class name or a type of an element, a name and an extension of a file. In some instances, the attribute may also include a definition, a structure, and an administration of the data files with content in context.

The treemap may include colors or patterns for backgrounds or bars of the polygons to provide visualizations of the multiple attributes. A bar may be rectangular in shape. For example, a bar may be a horizontal bar placed approximately at a top portion of the polygon or may be similar to a data bar used in bar charts. When the bar is a data bar, it may be positioned in a vertical or a horizontal position. An attribute is a specification that defines a property of an object, element, or file. The colors or patterns associated to the multiple attributes provide visual cues that aid the user when looking for patterns of data (e.g., content information) or at the various levels of content information. The user interface fosters an intuitive and viewer friendly environment for viewing the hierarchical levels of data, mining of the data, and providing interactions with the data.

The user interface pane presents a treemap visualization of the large-scale hierarchical data that may be displayed on a screen in predefined and resizable areas. The user may navigate around areas in the treemap and intuitively resize the areas via a single actuation event, such as a single mouse click.

While aspects of described techniques can be implemented in any number of different computing systems, environments, and/or configurations, implementations are described in the context of the following illustrative computing environment.

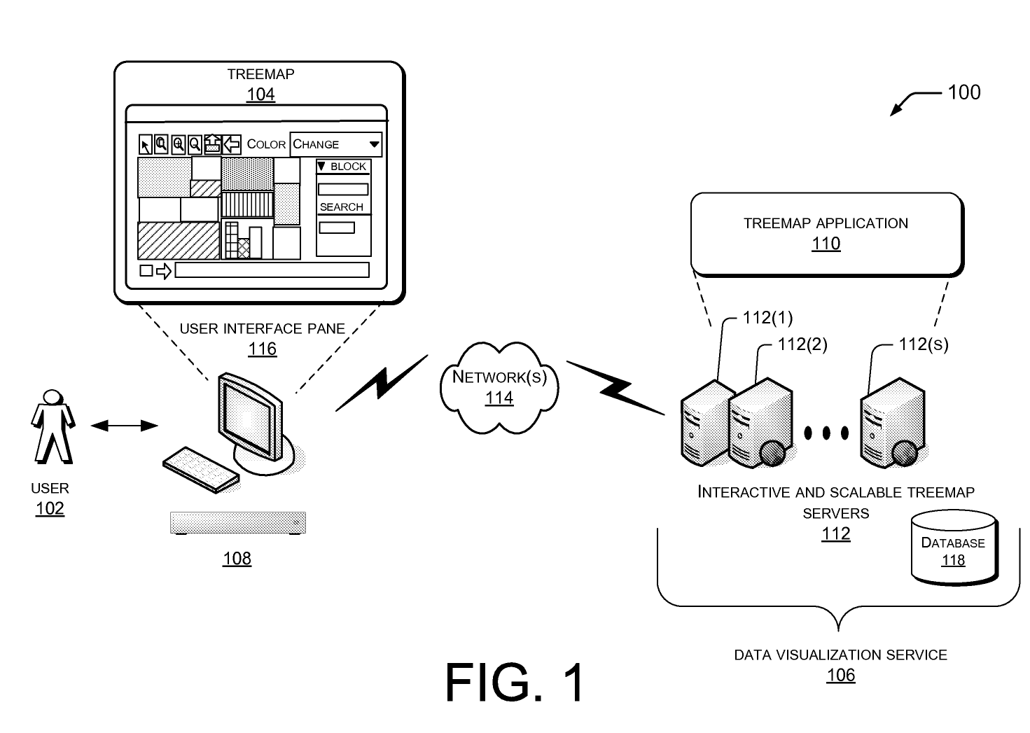

FIG. 1 is a diagram of an illustrative architectural environment 100, that enables a user 102 to view large-scale data in the form of a treemap 104, while also allowing the user 102 to interact with the treemap 104 in various ways, such as by interactively scaling the treemap 104. The term “treemap” may be used interchangeably with the terms “interactive and scalable treemap.”

The environment 100 includes a data visualization service 106 that may be accessed by a computing device 108 to view a collection of large-scale data in a treemap format. The data visualization service 106 in this implementation is implemented by a treemap application 110, which in turn executes on one or more interactive and scalable treemap servers 112(1) . . . 112(S).

The computing device 108 may access the data visualization service 106 through a network 114, which in some implementations may comprise the Internet. In many embodiments, the computing device 108 may access the data visualization service 106 using an Internet browser.

FIG. 1 shows an example of a user interface pane 116 that may be presented to the user 102 upon accessing the data visualization service 106. The user interface pane 116 shows a treemap 104 that has been provided or generated by the data visualization service 106. As will be described in more detail below, the treemap 104 is interactive and scalable.

The environment 100 includes an exemplary computing device 108, which is shown as a desktop computer. The computing device 108 may take a variety of forms, including, but not limited to, a portable handheld computing device (e.g., a smart phone, a cellular phone, a personal digital assistant), a laptop computer, a portable media player, a tablet computer, a netbook, or any other device capable of connecting to one or more network(s) 114 to access the data visualization service 106 for the user 102.

The network(s) 114 represents any type of communications network(s), including wire-based networks (e.g., public switched telephone, cable, and data networks) and wireless networks (e.g., cellular, satellite, WiFi, and Bluetooth).

The data visualization service 106 represents a data-based application service that may be operated as part of any number of online service providers, such as a data service, an information service, a search service, a news service, an e-commerce service, or the like. A purpose for the data visualization service might be to leverage the treemap in some manner on a website or on servers operated by the data visualization service 106 or another third party service.

The treemap application 110 may comprise a data-based application that may be implemented as part of the data visualization service 106 to provide the treemap 104 to the user 102. The treemap application 110 and the data visualization service 106 may each be a component that includes additional sub-components, sub-modules, or works in conjunction with other modules or components to perform the operations discussed below.

As mentioned, the data visualization service 106 is hosted on one or more interactive and scalable treemap servers, such as servers 112(1), 112(2), . . . , 112(S), accessible via the network(s) 114. The interactive and scalable treemap servers 112(1)-(S) may be configured as plural independent servers, or as a collection of servers that are configured to perform larger scale functions accessible by the network(s) 114. The interactive and scalable treemap servers 112(1)-(S) may be administered or hosted by a network service provider that provides the data visualization service 106 to and from the computing device 108. The treemap application 110 organizes the huge volume of data in polygons, enables visual data analysis, and enables information sharing among multiple users at the same time.

The environment 100 may also include a database 118, which may be a separate server or may be a part of the representative set of servers 112 that is accessible via the network(s) 114. The database 118 may host large-scale hierarchical data, host layouts of the treemap 104, store information generated by the treemap application 110, store customized views of the treemaps, store algorithms, and may be updated on a predetermined time interval. For instance, the database 118 may store the large-scale data that is arranged in the hierarchical order in the treemap 104 to ten or more million nodes.

### Exemplary Interfaces for the Interactive and Scalable Treemap

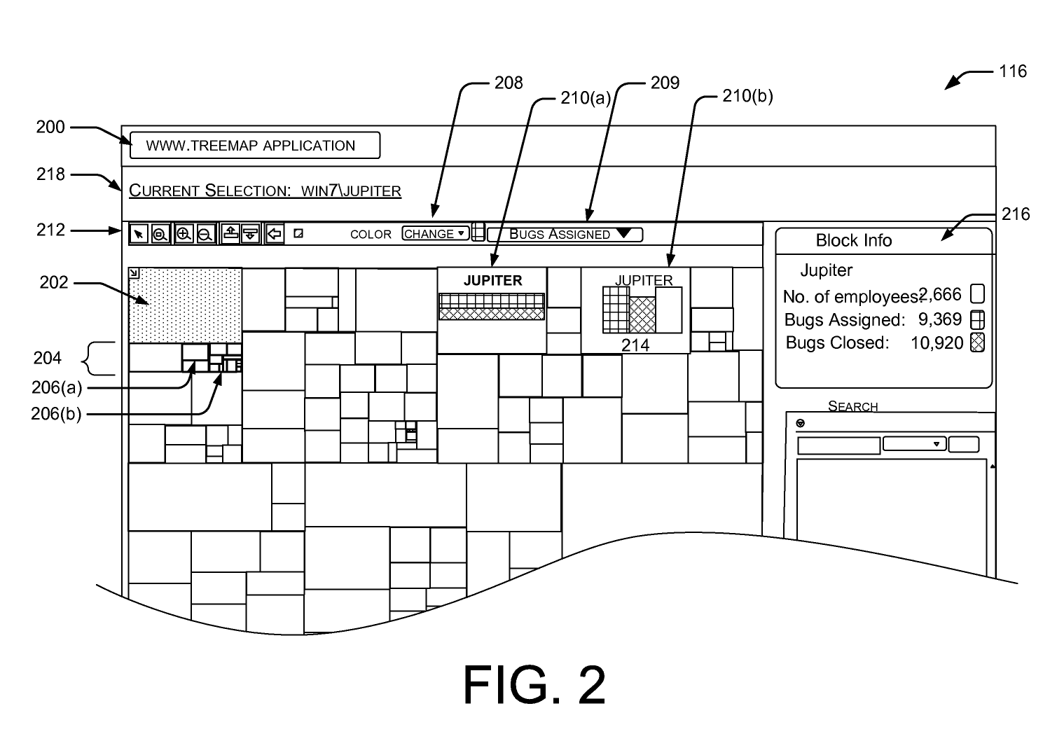

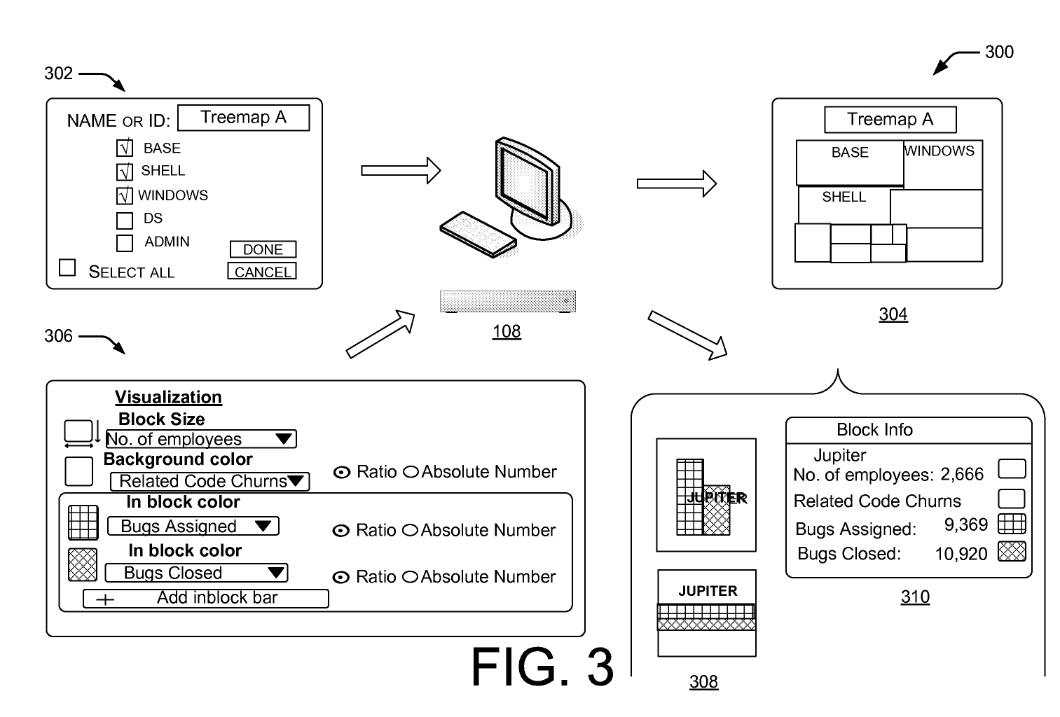

FIGS. 2, 4, and 5 show illustrative user interfaces (UIs) for a treemap 104. FIG. 3 illustrates an example process for using features in the illustrative UI. For discussion purposes, the UIs are described with reference to the UI pane 116 of the computing environment 100 shown in FIG. 1. However, the UIs may be activated using different environments and devices. The tools in the UI diagrams may be referred to as bar navigation elements, bar commands, navigation commands, navigation buttons, and the like. Also, several examples of data are used as input to create the treemap in the description.

FIG. 2 shows one example of a user interface pane 116 that may be presented to the user 102 on a display of the computing device 108. The data visualization service 106 enhances the user experience by providing the user interface pane 116 for visualization and interaction of the large-scale data arranged in the treemap format. The user interface pane 116 facilitates access to the data visualization service 106 that provides data-based services, such as the treemap 104.

In an implementation, the user interface pane 116 is a browser-based UI 200 that presents a page received from the data visualization service 106. The user 102 employs the user interface pane 116 to submit a request to access the data visualization service 106. For example, the user 102 may access one or both, the data visualization service 106 and/or the treemap application 110 to access the treemap 104.

The content of the entire treemap 104 may be easily visualized in a small amount of display area. The generated treemap 104 may be used for visualizing layout of data in a variety of areas, such as scientific research, data mining, financial data analysis, source coding, debugging, e-commerce, organizations, library and bibliographic databases, healthcare industry, sports activities, system monitor, election results, and more.

The treemap has a recursive construction that allows it to be extended to hierarchical data with any number of levels. Approximately 20-90 nodes may be shown at one to three levels or thousands of nodes may be shown at five to seven levels at once on the display. The treemap application 110 creates the treemap 104 by dividing the branches into sub-branches, where an initial branch is a root node or a parent node that is represented by a polygon 202. Other shapes that may be used for the treemap, include but are not limited to: rectangles, squares, circles, ovals, and the like. Shown is another branch of the tree-structure, which is represented by a polygon 204. The polygon 204 has been divided into sub-polygons, shown as smaller polygons, and further divided until there are no more sub-polygons. These sub-polygons (e.g., sub-branches) are referred to as children, grandchildren, ancestors, and the like of the parent.

The user 102 may further assign a value for the attribute based on knowledge or distribution of the content information. The attribute may be used to calculate sizes of the polygons and sub-polygons, such as small, medium, and large size polygons, depending on a value of an attribute. For instance, larger files tend to have larger polygons representing them. The value of the attribute is discussed in more details with reference to FIG. 3.

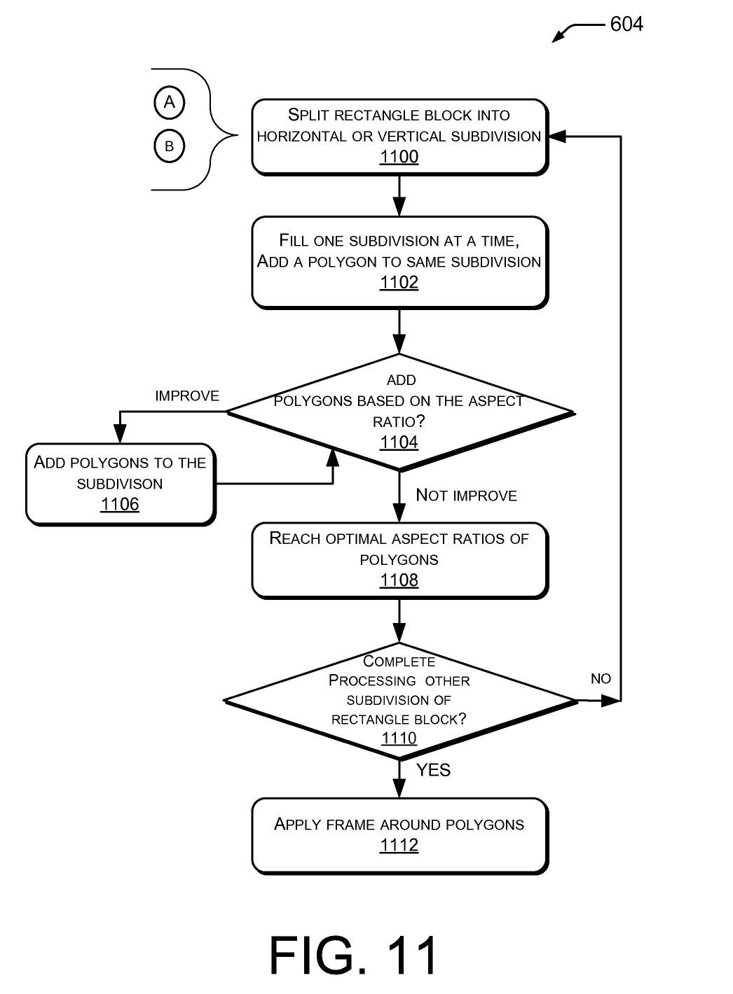

Shown are two sub-polygons located on top and bottom at 206(a) and a plurality of smaller sub-polygons at 206(b). To preserve ordering of the data, it is desired that the polygon 202, 204, the sub-polygons 206(a), and the plurality of smaller sub-polygons 206(b) have an aspect ratio close to one, which affects their shape. The aspect ratio is a ratio of the width of the polygon to its height, typically expressed by two numbers, such as 4:3. A detailed discussion of dividing the polygon into sub-polygons follows with reference to FIG. 11. Furthermore, a border surrounds the following items: the large polygon 204, the sub-polygons 206(a), and the plurality of smaller sub-polygons 206(b) to illustrate the information is grouped for similar content. For instance, the information inside the border pertains to a branch and its sub-branches that belong to a directory tree-structure.

Visualization of the treemap is highly desired to allow the user 102 to quickly analyze the data. At 208, the user 102 may visualize or highlight an attribute by selecting change for a background color or by selecting none (not shown). For example, a visualization tool allows the user 102 to change a pattern of a background of a polygon 202 from a solid pattern to small dots. The treemap application 110 presents the attribute to be visualized as small dots in the background of the polygon 202.

A bar or an in-block bar may help visualize or highlight additional attributes pertaining to the polygons or sub-polygons. Any shape may be used to visualize the attributes. The visualization tool allows the user 102 to also change a color or a pattern of a bar or in-block bar. Shown at 209 is an attribute identified as “Bugs Assigned” where the user 102 has selected a pattern to highlight the attribute. The details for the visualization menu are discussed with reference to FIG. 3.

The treemap illustrates how the colors or patterns of the background or the bar provide an overview visualization. In some implementations, a name (e.g., text or label) of an attribute is positioned on top or placed over the bar(s) and background. For purposes of discussion, the terms polygon and block may refer to representing the node that is part of the treemap. Also, the terms in-block bar and data bar may be used to refer to the “bar” shown in the polygons. The treemap application 110 may create multiple in-block bars as shown. For example, the in-block bars 210(a) shows a first in-block bar with a pattern of horizontal and vertical lines and a second in-block bar with a pattern of cross-hatches. The in-block bars 210(a) are shown as horizontal blocks or bars with the text “Jupiter” over them. Turning to another implementation, the bars 210(b) are shown as three data bars of attributes with “Jupiter” slightly above them. In another implementation, a small sub-polygon may be used to visualize a quantity with a pink color, such as file share or market share.

FIG. 2 also illustrates a row of navigation commands 212. The navigation commands 212 are shown graphically with an arrow or a pointer, a magnifying tool, although other representations may be used. For example, a first command is an arrow placed at an angle that enables the user 102 to use a mouse to select a polygon area, a polygon region, several sub-polygons in the treemap. The user 102 may view information contained in the polygon by selecting the polygon 214 with detail information displayed on a right panel 216. Next, are the navigation commands for zoom in (+) and zoom out (−) features. The zoom in and zoom out features enable the user 102 to view certain portions, polygons, or sub-polygons of the treemap at varying sizes. For example, the zoom in feature allows the user 102 to identify a polygon area to zoom in or to magnify, such as resizing the polygon area of the treemap to a larger size. In an implementation, there may be various sizes preset for zoom in, such as 50%, 75%, 100%, 150%, 200%, and so forth. Furthermore, the zoom out feature may resize the polygon of the treemap back to its previous size or the zoom out may resize the polygon down to its original size by continued clicking.

Shown next in the row of navigation commands are an example set of bar commands for leveling up or leveling down of the treemap. For example, a “level-up” feature is represented with an arrow pointed upward and a “level-down” feature is represented with an arrow pointed downward. The level-up feature enables the user 102 to view high level polygons, such as parent nodes or the branches in a current view of the treemap. The level-down feature enables the user 102 to view low level polygons of data, such as children nodes or sub-branches in the current view. In an implementation, the level-down feature may show a single level of children nodes in the treemap. The navigation commands 212 enable interactions by enabling movement from a level to a next level in an hierarchical order of the content information. In an implementation, the level feature may hide a lowest level of polygons in a current view by continuing to click on the “level-down” feature until the lowest level polygons are no longer displayed.

In an implementation, the user interface pane 116 may include three levels, with level one illustrating a background color, an in-block bar change, a search feature, a timeline change, and filter custom views. With level two, the user interface pane 116 allows one to drill down to the level of data. With level three, the user interface pane 116 allows one to level up, level down, zoom in, and zoom out.

Last in the row of navigation commands 212 is a back arrow to navigate to a previous view.

A path of a selected polygon is shown at 218. For example, the user 102 selects a polygon and the path of the selected polygon from the root node to the selected node is illustrated in 218. The user 102 may click on any node in the path to navigate to it.

FIG. 3 illustrates an example process 300 of providing information by the user 102 on the computing device 108 that is received by the servers 112. The information received by the servers 112 is used by the treemap application 110 to create the customization for the visualization of the treemap displayed on the user interface pane 116.

At 302, example commands for supporting customizable views are shown. The command 302 enable the user 102 to create or to select custom views of the data of the treemap. The command 302 allows the multiple users to specify customized views to show a portion of the whole hierarchical data of the treemap. The servers 112 may create a folder to contain a custom view data 302. For example, each individual user may desire to view a location of a current polygon area that is visible in the whole treemap. In particular, the area may be more relevant or of interest to the user 102 than other polygon areas of the treemap. When the custom view data 302 is saved, the user 102 or other users may share information associated with the customized view data 302.

The user 102 may further define the customized views by specifying a new treemap identification (ID) in an edit box and specify nodes or sub-nodes in the treemap that may be included in a new view. The user 102 may specify the ID or a name that is unique to a treemap, such as “Treemap A.” The treemap application 110 uses this unique ID or name to reference corresponding tree data. Also shown at 302 is a list of properties for the tree node, such as <AttributeDefinition>. These properties may be illustrated in the treemap 104, as either colors or patterns in backgrounds and/or bars of polygons.

At 304, shown is the unique ID or name of “Treemap A” along with names (e.g., text or label) used to identify the attributes of the tree nodes. Shown are names defining attributes of the tree nodes: Base, Windows, and Shell. The user 102 may have provided as input a list of definitions for these attributes.

At 306, the user 102 clicks on a visualization menu to choose a block size, a background color (or a pattern), or as an in-block color (or a pattern). At 306, the user 102 also clicks on a visualization menu to choose attributes that he or she wants to view as a block size, a background color (or a pattern), or as an in-block color (or as a pattern). The treemap application 110 allows the user 102 to provide their own algorithm to calculate the background color depth “ratio” for the attribute. The user may provide their own calculation based on knowledge or experience of own data and the attribute value distributions. By clicking on ratio, the user relies on their own calculation to provide a reasonable visual effect for display of the attribute. The other choice is to use an absolute number.

The value of a primary attribute used to calculate a polygon size should satisfy a constraint. The value of a root node or a parent node should be equal to a sum of the attribute values of all of its children nodes. This constraint ensures the polygon of a parent node may be fully occupied by all of its ancestral nodes.

The treemap application 110 receives input of the value of the user-defined properties. The treemap application 110 may not actually use the value of the primary attribute for the non-leaf nodes provided by the user 102. Rather, the treemap application 110 assigns the attribute value of the non-leaf nodes by summing up the attributes of the children nodes. For example, the directory tree may include three nodes, one parent node “Root” and two children nodes “c1” and “c2.” An actual SizeCount of node “Root” is five, which is a sum of SizeCount for c1 and c2. If the user had specified a SizeCount “2” for “Root,” this tends to be ignored in order for the polygon of a parent node to be fully occupied by all of its ancestral nodes.

In another implementation, a default value of the attribute or the property is used when the value is not defined in a tree node. The default value is calculated by a current attribute value divided by a max attribute value. The process 300 identifies whether the attribute or the property has temporal data associated with it. If the property has temporal data, time series data should be provided in a separate text file by the user 102.

Shown at 308 are two examples illustrating visualization of the attributes in the polygon. For instance, the in-block patterns of horizontal and vertical lines are shown for “Bugs Assigned” and in-block patterns of cross hatchet lines are shown for “Bugs Closed.” In the top polygon, the blocks are positioned in a vertical position with “Jupiter” placed directly over them. In the bottom polygon, the two in-block bars are positioned as sub-headers with “Jupiter” placed on top of them. In another implementation, colors may be used to visualize the different attributes for the blocks of data, such as red, green, blue, yellow, and other colors.

Shown at 310 is the block information that the user 102 sees upon clicking on the polygon at 308. In other words, the process 300 creates a map by distributing the information in the treemap format, connecting the nodes, and laying the attribute information on top of the polygons. The visualization of the attributes shown as text with background and bar colors or patterns provide a easy to visualize directory mapping. Furthermore, if the user 102 clicks on one aspect of the polygon, detailed information pertaining to the polygon is shown at 310. The information in the treemap may be presented in 2D or 3D. 3D tends to show the information of a width, a length, and a depth of the polygon.

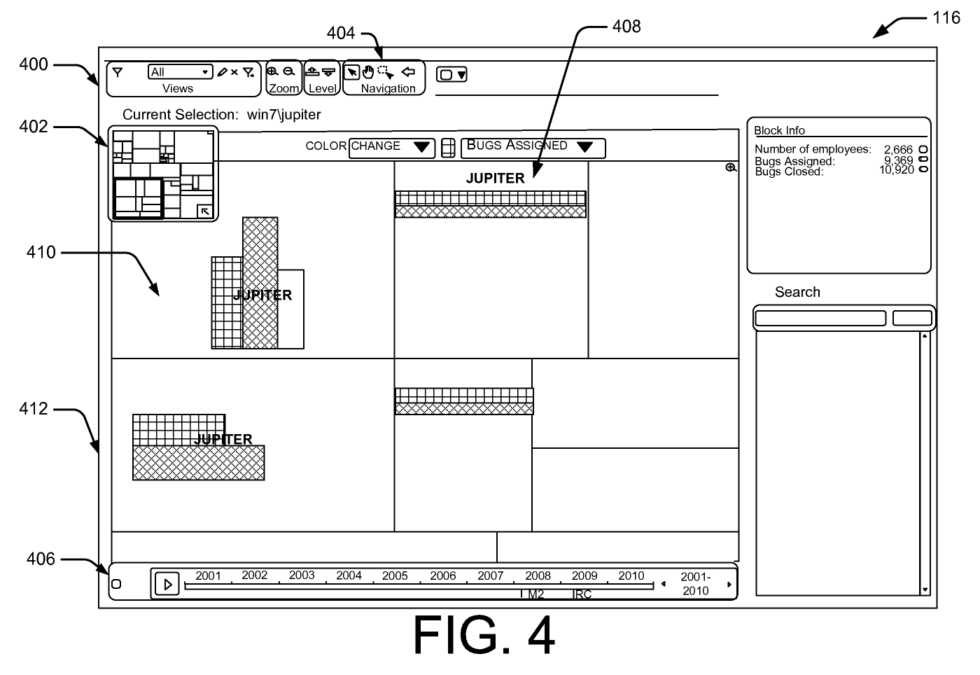

FIG. 4 shows another example of a user interface pane 116 that may be presented to the user 102 on a display of the computing device 108. It is understood the illustrative user interface pane 116 has features similar to the components and features of the user interface panes as discussed in FIGS. 2 and 3. However, the following descriptions will focus on features that are different for other implementations of the user interface pane.

At 400, example commands for navigating are shown. A UI pane 116 enables the user 102 to highlight a location of a current visible area in the whole treemap. At 402, an overview pane provides context of a current view. The overview pane 402 shows a location of current view in the entire treemap. The user 102 may easily navigate to relevant areas by using the overview pane 402. At 404, an example set of navigation commands that provides interactive functionalities is shown. The navigation commands 404 are shown graphically with an arrow or a pointer, a hand tool, a rectangle tool, and a backward arrow, although other representations may be used. For example, a first command is an arrow that was discussed with reference to FIG. 2. A second command is a hand tool that enables the user 102 to page through the treemap to see links of the nodes. A third command is the rectangle tool that enables the user 102 to click and to enlarge a polygon region on any portion of the treemap to occupy a full screen. A fourth command is a backward arrow that allows the user 102 to navigate back to a previous view.

At 406, a functionality that provides trending or a time series control of the content information to enable visualizing of the attributes. The attributes may have temporal information in a specific time interval or there may be an interpolation of the data along a time period. The trending functionality 406 enables the user 102 to use a bottom timeline control to illustrate trending of an attribute. The user 102 may click on a specific time point in the timeline control to view its value or click on a play button to view an animation, illustrating a value of the attribute changing over a period of time. Alternatively, the interpolation may project the information based on known time periods or display. For example, the periods of time shown in FIG. 4 are dates for each year and from 2001 to 2010. The information may show a month, a day, and a year for the trending information. The user 102 may provide the information along with a starting time and an ending time.

At 408, the in-block bars are displayed as sub-headers under “Jupiter.” At 410, the in-block bars are displayed in a vertical manner with the name of the attribute laid on top of them. Shown at 412 is another implementation, where the in-block bars are displayed in a horizontal manner with the name of the attribute laid on top of them. These are just three methods of displaying the data in in-block bars, while there are many other possible techniques to display the data.

In an implementation, the user may select a background color or pattern and an in-block color or pattern to visualize the attributes. In another implementation, the process may only identify either a color or a pattern for the background or the in-block bar.

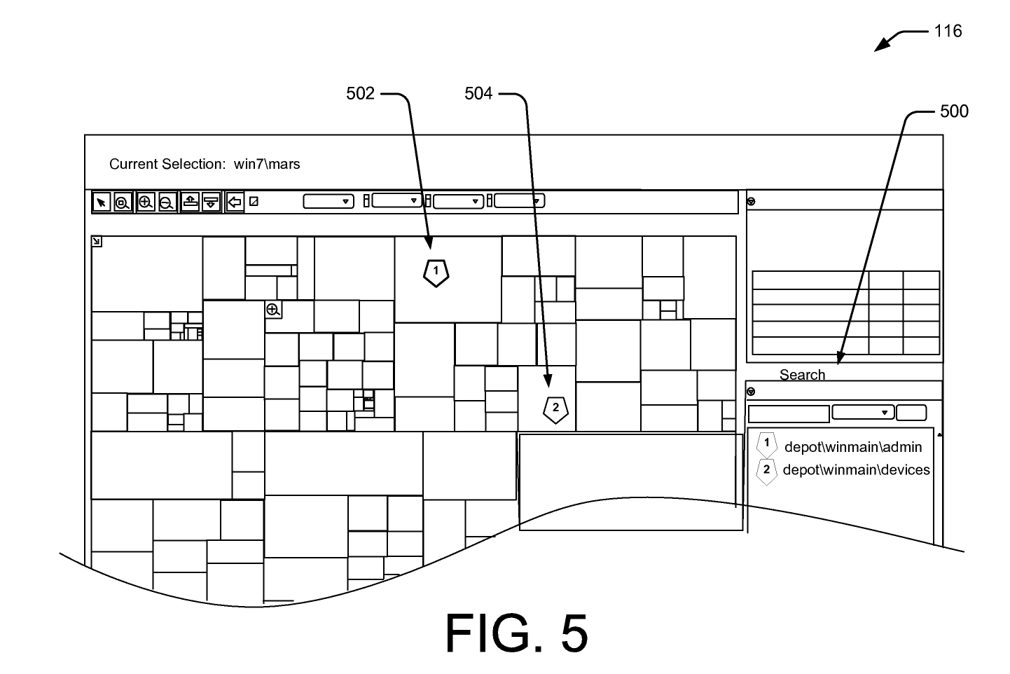

FIG. 5 shows another example of a user interface pane 116 that may be presented to the user 102 on a display of the computing device 108. It is understood the illustrative user interface pane 116 has features similar to the components and features of the user interface panes as discussed in FIGS. 2-4. However, the following descriptions will focus on features that are different for other implementations of the user interface pane.

At 500, a functionality to provide searches is shown. The search feature 500 may be implemented by the search component based on the user's search logic. The search feature conducts a search of the node path string for a partial match. The user's search logic is used to retrieve a result path list of the query. The search feature 500 enables the user 102 to search the treemap for specific topics or items of interest. In an implementation, the user 102 may search for a query word or query words based on a query input. Once the search is completed, the results of the search are displayed in a numerical order with a list of the search results or a path of the search results. This enables the user 102 to visually view the search results, the different levels, and a pattern of the search results.

For example, the results of the search feature 500 show two items that are numbered, as 1 and 2. Item 1 is shown at 502 and item 2 is shown at 504 in the treemap. This helps provide a visual to the user 102 where the data pertaining to items 1 and 2 are located in the treemap and in relationship to each other. This further enables the user 102 to view patterns or view relationships among the data in the treemap. The number 1 corresponds to the numerical order, where the number 1 is placed on the polygon as shown at 502.

### Overview Illustrative Process Phases

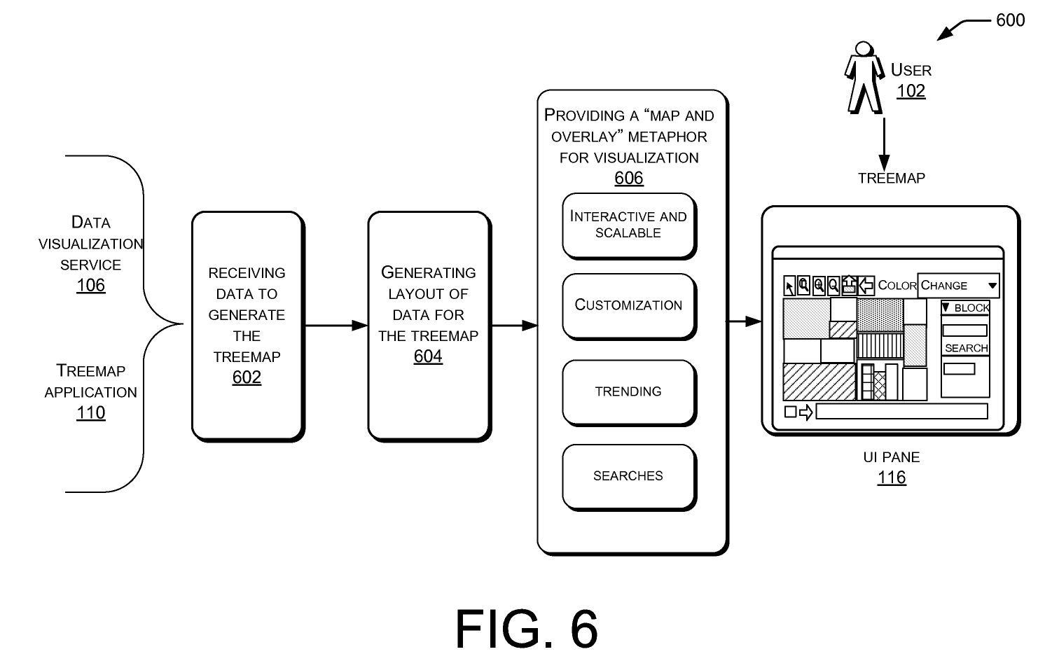

FIG. 6 is a flowchart showing an illustrative overview process 600 of high level functions performed by the data visualization service 106 and/or the treemap application in operation with components on the computing device 108. The process 600 may be divided into three phases, an initial phase of receiving data to generate the treemap 602, a second phase of generating layout of data for the treemap 604, and a third phase of providing a “map and overlay” metaphor with reference to the treemap for visualization 606. All of the phases may be used in the environment of FIG. 1, may be performed separately or in combination, and without any particular order.

The first phase is receiving data to generate the treemap 602. The data may include receiving large-scale data by the data visualization service 106 and/or the treemap application 110. The large-scale hierarchical data may have as many as one or more million nodes. The data may be received from different sources, such as data files, a custom data adaptor, or a web application.

The second phase is generating layout of data for the treemap 604. The layout generated by the data visualization service 106 or the treemap application 110, includes dividing an initial rectangle into two sub-divisions and further dividing each subdivision into a custom shape until an optimal aspect ratio is reached. The layout also includes determining whether to add new rows and/or to add frames around the custom shapes to the treemap 604.

The third phase is providing a “map and overlay” metaphor with reference to the treemap for visualization 606. The “map and overlay” metaphor refers to a visualization of attributes of the polygons of the treemap 104 and allowing the user 102 to explore links, paths, and various levels, similar to exploring a map. The user 102 may navigate and customize the treemap 104. Furthermore, the user 102 may desire to see trending of the data in the treemap along with searching the data in the treemap for specific information.

### Illustrative Computing Architecture, Devices, and Applications

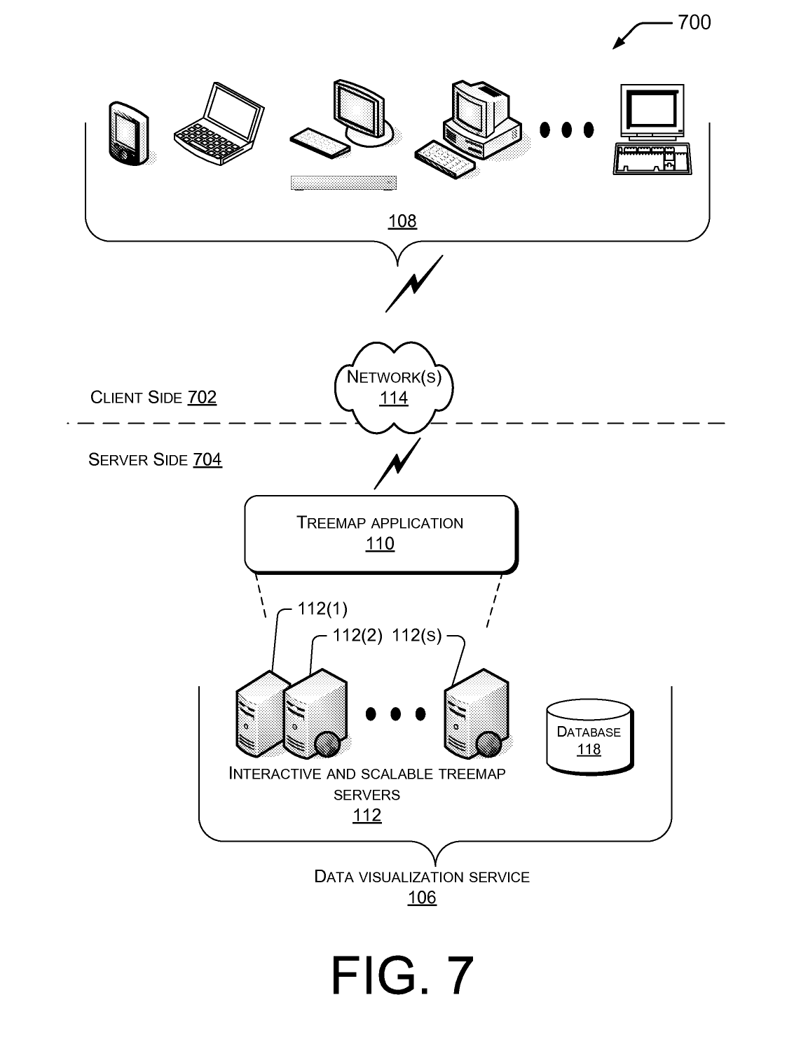

FIG. 7 is a block diagram 700 showing illustrative computing devices 102 and the illustrative interactive and scalable treemap servers 112(1)-(S) that are usable with the environment of FIG. 1 and the high level functions of FIG. 6.

The computing devices 108 are located on a client side 702. The computing devices 108 may belong to single or multiple users, allowing the individual user 102 or multiple users to access the data visualization service 106 that is hosted by the servers 112. In particular, the user 102 or multiple users of the computing devices 102 may provide input data, access a variety of information provided by the treemap 104, further customize the information, and conduct searches. The users may share information with each other by sending or saving custom views created of the treemap. The data visualization service 106 defines how many user-defined views may simultaneously stay in memory.

The UI pane 116 may retrieve corresponding data of the treemap 104 from the interactive and scalable servers 112 when processing the user's navigation commands on the treemap. In particular, the user 102 interacts with the commands causing the UI pane 116 to modify the visible area of the data on the treemap and to send the visible area to the servers 112 to request corresponding layout data. The interactive and scalable servers 112(1)-(S) render the information based on the layout data to the monitor on the computing devices 102 for visualization. The servers 112 retrieve the tree nodes within the UI pane 116 and sends their structures and coordinates back to the computing device 108. Upon receiving this information, the computing device 108 updates the visualization of the treemap accordingly. Thus, the UI pane 116 based layout retrieval provides a general implementation for different treemap interactions.

The interactive and scalable treemap servers 112(1)-(S) are located on a server side 704. The interactive and scalable treemap servers 112(1)-(S) host the data visualization service 106 and the treemap application 110. The servers 112(1)-(s) also calculate and organize the layout for the treemap 104. In an implementation, the interactive and scalable treemap servers 112(1)-(S) may render the treemap 104 to the computing devices 108 when activated by the data visualization service 106. Furthermore, the data visualization service 106 performs functions that include but are not limited to: mapping of the data from the servers, managing data transfer, designing a caching mechanism, and applying a series of views.

The data visualization service 106 maps the layout of the data from the servers 112 to the different views in the UI pane 116 of the computing device 108. The servers 112(1)-(S) may further retrieve the tree nodes using a recursive algorithm to display in the UI pane 116. A retrieval process starts from a root node and follows the tree structure to check its descendant recursively. The retrieval process is based on using tree nodes if its polygon has intersections with the UI pane 116, displaying polygons based on a threshold value having about a width and about a height greater than ten pixels, and displaying a child node and its siblings if the nodes satisfy criteria for the threshold value.

The data visualization service 106 further manages, handles, or processes data transfer between the computing device 108 and the servers 112(1)-(S). The data visualization service 106 maintains a partial tree on the computing device 108 to cache a previous retrieval result. The partial tree includes a sub-tree with non-leaf node (e.g., an open node) of a whole tree stored on the servers 112(1)-(S). The data transfer occurs between the servers 112(1)-(S) and the computing device 108 upon the user 102 activating the commands. Interactions on the UI pane 116 retrieve the nodes for display on the partial tree.

The recursive process may encounter an open node whose size is large enough to drill down to display its children, recording this node as a missing node. When the recursive process finishes, if there is no missing node, the computing device 108 may not send a request to the servers 112(1)-(S) since the nodes that should be displayed are already available on the computing device 108. However, if there are missing nodes, the computing device 108 sends a missing node list and a current layout to the servers 112(1)-(S). For each missing node, the servers 112(1)-(S) may conduct similar retrieval process to retrieve the nodes for display in the UI pane 116. Next, the data visualization service 106 sends a result list of the nodes

The data visualization service 106 further applies a series of views to the UI pane 116 to make transitions smooth. For example, the user 102 triggers navigation commands that cause the data visualization service 106 to implement an animation based on calculating a series of views by interpolating between a current layout and a new layout.

In another implementation, the interactive and scalable treemap servers 112(1)-(S) may process the data received that include but are not limited to parsing, filtering, aggregating, and analyzing.

The database 118 is also located on the server side 704. The database 118 may be a separate server or may be with a representative set of servers 112(1)-(S). The database 118 may host large-scale hierarchical data, host layouts of the treemap 104, store custom views, additional information and the like.

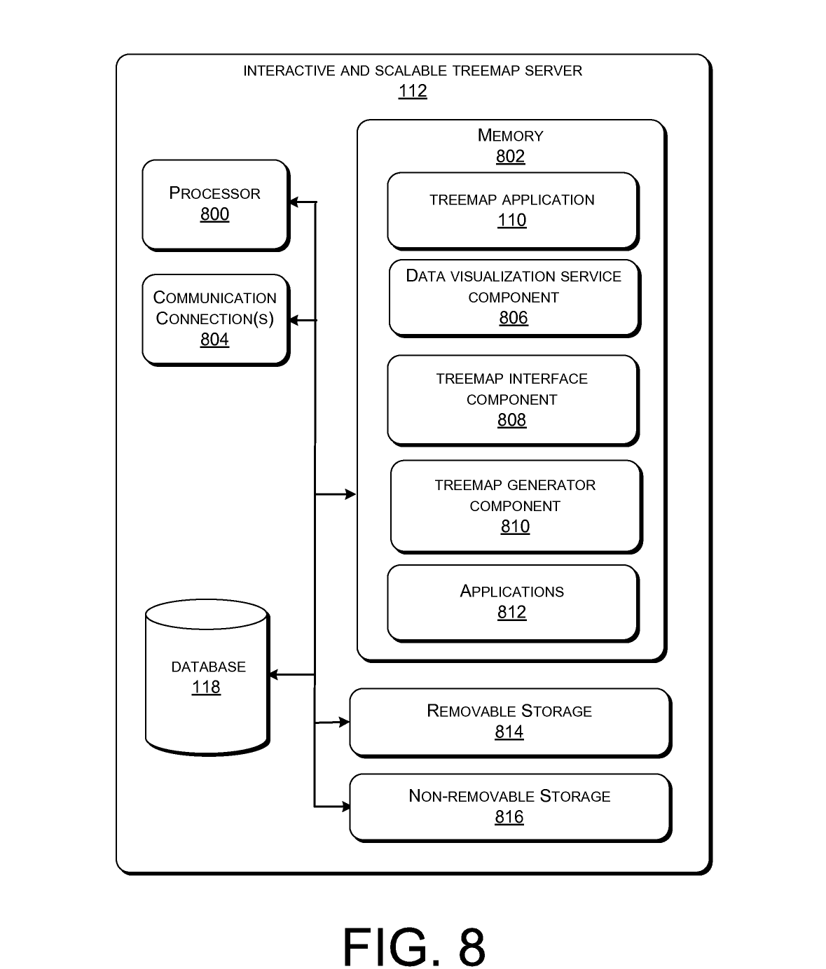

FIG. 8 is a block diagram showing selected components in a representative computer system that may be used to implement the data visualization service 106 hosted on the one or more of the servers 112(1)-(S).

In one illustrative configuration, the interactive and scalable treemap server 112 has processing capabilities and memory suitable to store and to execute computer-executable instructions. The interactive and scalable treemap server 112 includes one or more processors 800, a memory 802, and a communication connection(s) 804. The communication connection(s) 804 provide access to communicate over the network(s) 114 with the computing device 108.

Turning to the contents of the memory 802 in more detail, the memory 802 may store the treemap application 110, an data visualization service component 806, a treemap interface component 808, a treemap generator component 810, applications 812, and the database 118. Although shown as separate components, the treemap application 110 and the treemap generator component 810 may be implemented as one or more applications or modules, or may be integrated as components within a single application. In some instances, the components may be referred to as one or more navigation buttons.

The treemap application 110 may work in operation with the data visualization service component 806. The functions described may be performed by the treemap application 110 and/or the data visualization service component 806 or even other components. Alone or in combination, these two components may receive many types of input information, calculate layout of the treemap 104 based at least in part on an optimal aspect ratio of a polygon shape, generate the treemap 104, perform a “map and overlay metaphor” with reference to the treemap, provide a search feature, and perform other functions.

The treemap interface component 808 interacts with the treemap application 110 and the data visualization service component 806. The treemap interface component 808 provides the user interface pane 116 to the user 102, defines selection and arrangement of items in context of the treemap 104, provides visualization of the treemap 104 to the user 102 on the computing device 108, and interacts with information from the other components to receive interaction and customization instructions from the user 102.

The treemap generator component 810 creates, builds, or generates the treemap 104. The treemap generator component 810 receives data input, and receives the layout calculated by the treemap application 110 based at least in part on the optimal aspect ratios of the custom shapes. In addition, the treemap generator component 810 determines whether to add frames or borders around the custom shapes and/or whether to add rows of children to the treemap 104.

The interactive and scalable treemap server 112 may include the database 118 to store a collection of input, the treemap 104, different analysis performed on the treemap 104, and custom views created of the treemap 104.

The interactive and scalable treemap server 112 may also include additional removable storage 814 and/or non-removable storage 816. Any memory described herein may include volatile memory (such as RAM), nonvolatile memory, removable memory, and/or non-removable memory, implemented in any method or technology for storage of information, such as computer-readable storage media, computer-readable instructions, data structures, applications, program modules, emails, and/or other content. Also, the processor 800 described herein may include onboard memory in addition to or instead of the memory 802 shown in the figure. The memory may include storage media such as, but not limited to, random access memory (RAM), read only memory (ROM), flash memory, optical storage, magnetic disk storage or other magnetic storage devices, or any other medium which can be used to store the desired information and which can be accessed by the respective systems and devices.

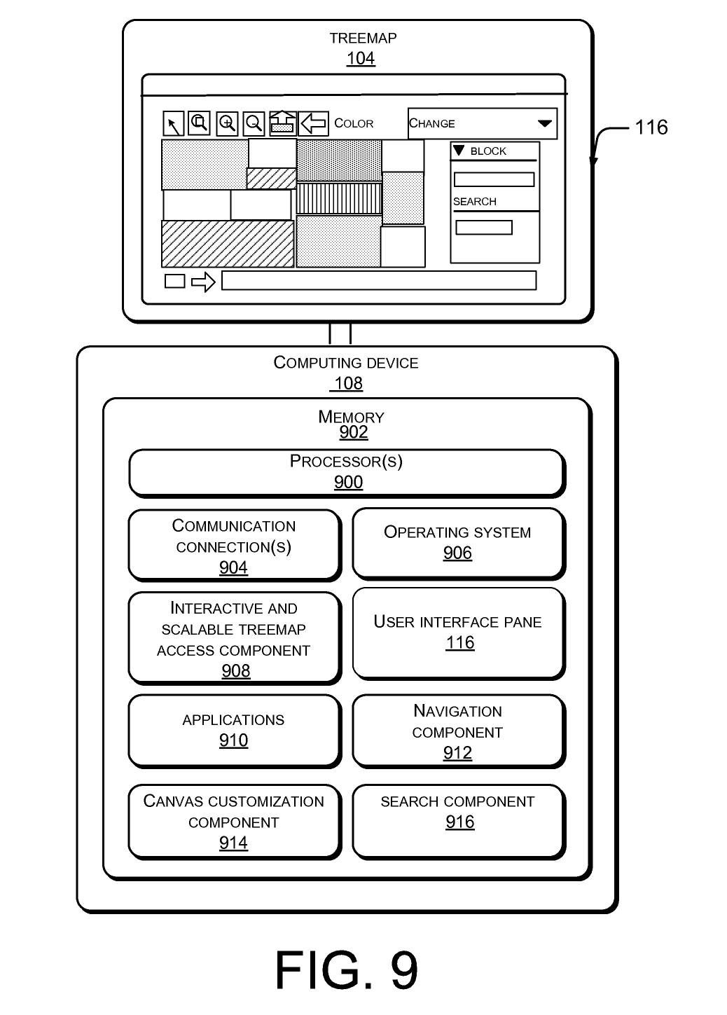

FIG. 9 shows selected components in the illustrative computing device 108 that may be used to access the data visualization service 106. The user interface pane 116 provides the display of the treemap 104, and interacts with information from the other components to provide interaction and customization with the treemap 104.

The computing device 108 has processing capabilities and memory suitable to store and to execute computer-executable instructions. In this example, the computing device 108 includes one or more processors 900 and memory 902. The memory 902 may include volatile and nonvolatile memory, removable and non-removable media implemented in any method or technology for storage of information, such as computer-readable storage media, computer-readable instructions, data structures, program modules, or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device.

In one illustrative configuration, the computing device 108 includes a communication connection(s) 904, an operating system 906, a treemap access component 908, the user interface pane 116, and applications 910. The communication connection(s) 904 may include allowing the computing device 108 to communicate over the network(s) 114 to access the data visualization service 106.

The operating system 906, the treemap access component 908, the user interface pane 116, and any number of applications 910 are stored in the memory 902 and executed on the processor 900 to enable accessing the data visualization service 106 for visualization, customization, and other functionalities of the treemap 104. Although shown as separate components, the treemap access component 908 and the user interface pane 116, may be implemented as one or more applications or modules, or may be integrated as components within a single application.

The treemap access component 908 may work in operation with the user interface pane 116. The functions described may be performed by the treemap access component 908 and/or the user interface pane 116 or even other components. The treemap access component 908 allows the computing device 108 access to the data visualization service 106 that is located on the server side 704.

In one illustrative configuration, the computing device 108 includes a navigation component 912, a canvas customization component 914, and a search component 916. The four components are stored in the memory 902 and executed on the processor 900 to enable the user 102 to interact with the treemap 104.

The navigation component 912 enables the user 102 access to navigation commands where the user 102 may select a rectangular or square shaped area (e.g. polygon) to interact with the information. The navigation component 912 enables the user 102 to view information in the selected rectangular or square shape in detail, enlarge the rectangular or square shape to occupy a full screen, drag a rectangular or square shape region, and navigate back to a previous view.

The canvas customization component 914 provides customization on laying out the information based on selecting colors or patterns for the background and in-block bars. This assists the user 102 to perform analysis of the data and view patterns in the data based on the visualization of the data (i.e., content information).

The search component 916 enables the user 102 to search for a query word or words. Once the search is completed, the results of the search are shown in a numerical order with a path of the search results shown and the order is shown on the treemap 104. This enables the user 102 to visually view the search results on the treemap 104, the different levels, and a pattern of the search results. In some instances, the components to perform functionalities may be referred to as one or more navigation buttons.

The interactive and scalable treemap server 112 from FIG. 8 and the computing device 108 from FIG. 9 as described above, may be implemented in various types of systems or networks. For example, the interactive and scalable treemap server 112 and the computing device 108 may be a part of, including but is not limited to, a client-server system, a peer-to-peer computer network, a distributed network, an enterprise architecture, a local area network, a wide area network, a virtual private network, a storage area network, an overlay network, and the like.

Various instructions, methods, techniques, applications, and modules described herein may be implemented as computer-executable instructions that are executable by one or more computers, servers, or telecommunication devices. Generally, program modules include routines, programs, objects, components, data structures, etc. for performing particular tasks or implementing particular abstract data types. These program modules and the like may be executed as native code or may be downloaded and executed, such as in a virtual machine or other just-in-time compilation execution environment. The functionality of the program modules may be combined or distributed as desired in various implementations. An implementation of these modules and techniques may be stored on or transmitted across some form of computer-readable storage media.

### Exemplary Processes for Interactive and Scalable Treemap

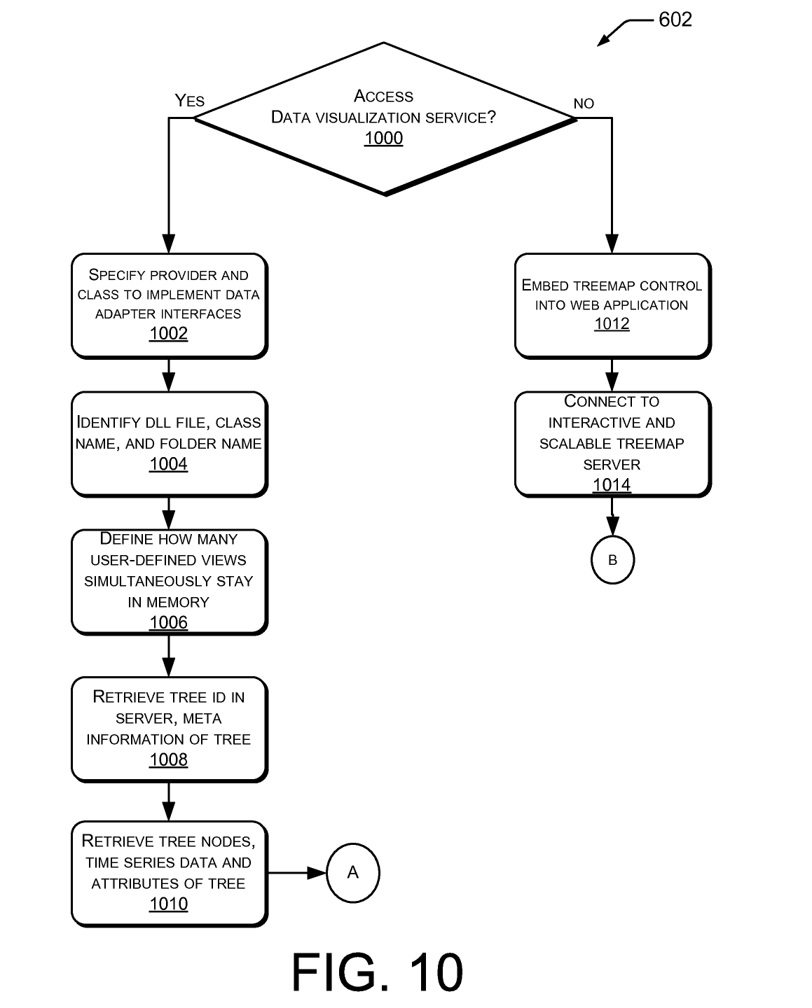

FIGS. 10-12 are flowcharts showing illustrative processes for the phases mentioned above. The processes are illustrated as a collection of blocks in logical flowcharts, which represent a sequence of operations that can be implemented in hardware, software, or a combination. For discussion purposes, the processes are described with reference to the computing environment 100 shown in FIG. 1 and the computing device 108 and the server(s) 112(1-)-(S) shown in FIGS. 8 and 9, respectively. However, the processes may be performed using different environments and devices. Moreover, the environments and devices described herein may be used to perform different processes.

For ease of understanding, the methods are delineated as separate steps represented as independent blocks in the figures. However, these separately delineated steps should not be construed as necessarily order dependent in their performance. The order in which the process is described is not intended to be construed as a limitation, and any number of the described process blocks maybe be combined in any order to implement the method, or an alternate method. Moreover, it is also possible for one or more of the provided steps to be omitted.

### Receive Data to Generate the Interactive and Scalable Treemap

FIG. 10 illustrates an example process for performing the phase 602 (discussed at a high level above) of receiving the data to generate the treemap 104. The data received is large-scale data that may include millions of nodes.

At block 1000, the user 102 may decide whether to access the data visualization service 106. If the user 102 accesses the data visualization service 106 (a yes branch from block 1000), the process proceeds to the left side when the user 102 provides data files to the data visualization service 106 through the computing device 108. In another implementation, the data visualization service 106 may retrieve the data from XML files based on the settings that follow.

At block 1002, the user 102 may specify a provider and class to implement data adapter interfaces to the data visualization service 106. For example, the computing device 108 is to be configured to access the data visualization service 106. For example, the computing device 108 may be configured based on a “Web.Config” file.

At block 1004, settings identifying dynamic-link library (dll) file, class name, and folder name may be provided to the data visualization service 106. The dll file may contain code, data, and resources, in any combination. In an example, the dll file name may be a DataProvider that implements the user interface to provide data. In some instances, a default implementation is to load Extensible Markup Language (XML) file data files. A class name implements the data provider interface, such as DataProvider dll. A folder name may be given, such as DataDir, which contains the data files. The servers 112(1)-(S) may load the data from the DataDir folder when it is launched. The DataDir may be a relative path to an data visualization service website directory. The data visualization service 106 may inform the DataProvider of an absolute path of the data file.

At block 1006, the setting may define how many user-defined views may simultaneously stay in memory. In particular, the data visualization service 106 determines the number of user-defined views that may occur simultaneously for multiple users. The multiple users may access the treemap from different computing devices at the same time.

At block 1008, the process retrieves the tree IDs in the interactive and scalable treemap server 112 and meta information of the tree.

At block 1010, the process receives tree nodes, time series data, and attributes for the tree. The data that may be downloaded using custom data adapters may be represented by A.

Returning to block 1000, the user 102 decides whether to access the data visualization service 106. If the user 102 decides to not access the data visualization service 106 (a no branch from block 1000), the process proceeds to the right side where the user 102 does not access the data visualization service 106.

Instead of accessing the data visualization service 106, at block 1012, the user 102 embeds a treemap control into a web application.

At block 1014, the user 102 then connects to the interactive and scalable treemap server 112 via the treemap control. The data that may be exchanged is represented by B.

### Generate Layout for the Interactive and Scalable Treemap

FIG. 11 illustrates an example process for performing the phase 604 (discussed at a high level above) of generating layout of data for the treemap 104. The functions may be performed by one or a combination of the treemap application 110, the data visualization service 106, and the interactive and scalable treemap process (hereinafter “process”).

The process receives large-scale data in a conventional treemap format or in rectangle blocks, shown as A or B. Initially, the process splits a rectangle block of the conventional treemap into two subdivisions.

At block 1100, the process further determines whether the rectangle block may be split into a horizontal subdivision or a vertical subdivision. The decision whether to split the rectangle block horizontally or vertically, is dependent on a size of an original or an initial rectangle block. For example, if the original or the initial rectangle block is wider than it is high, a decision may be to split the rectangle block into horizontal subdivisions. If the rectangle block is higher than it is wide, a decision may be to split the rectangle block into vertical subdivisions.

The process may split the rectangle block into a left side and a right side. Using the left side of the rectangle block as an example, the left side may be wider than it is high, so the left side of the rectangle block is split into a horizontal subdivision. The process performs the next steps on the left subdivision (i.e., the left side of the rectangle block).

At block 1102, the process fills one subdivision at a time and adds a polygon (e.g. square, rectangle, and the like) to the same subdivision. Also, the process calculates the aspect ratio of a polygon shape (e.g., a custom shape). The aspect ratio of a shape is a ratio of a longer dimension of the shape over a shorter dimension of the shape. For instance, the process continues creating the left subdivision, fills the left side, and adds the polygon to the left subdivision. The aspect ratio of this polygon may be about 9/4, which is the ratio indicating 9 for its longer dimension over 4 for its shorter dimension.

At block 1104, the process determines whether to add polygons based on the aspect ratio. The aspect ratio that is preferred is approximately close to one. The process identifies whether to add the polygons based on their aspect ratios.

If the next polygon to be added has a better or improved aspect ratio than a current polygon that has been added to the subdivision, the decision is to add the polygon. Thus, the process moves from 1104 to the left side, towards “improve.”

Shown at block 1106, the process adds polygons to the subdivision. The polygons that are being added should have better or improved aspect ratios than the current polygon. The process continues back to block 1104 and repeats the cycle.

Returning to block 1104, if the process determines the next polygon to be added does not improve the aspect ratio of a current polygon, the process proceeds down to “not improve,” to block 1108.

At block 1108, the process has reached optimal aspect ratios of the polygons. This indicates the optimal aspect ratios of the polygons selected are better or improved over the optimal aspect ratios of the previous polygons.

At block 1110, the process determines whether to complete processing other subdivision of the rectangle. If the process has processed only one subdivision, such as the left subdivision, the response is “no,” so the process moves along the “no” branch to the right side of block 1110 following the arrow. The process proceeds back to block 1102 and starts splitting a remainder of the rectangle block into the horizontal or vertical subdivision. Since the left side has been processed, the process now proceeds to the right side of the rectangle block, which is the right subdivision and starts the process on the right side of the rectangle block from 1100 to 1110.

Returning to block 1110, the process determines whether to complete processing other subdivision of the rectangle. If the processing has been completed for both subdivisions, (the response is a “yes”) which means the left subdivision and the right subdivision have been subdivided into smaller subdivisions. Then the process moves to block 1112.

At block 1112, the process applies a frame around the polygons, such as groups of data or subgroups. The frame helps strengthen the visualization of structure or groups. For example, groups of data or patterns of data may be surrounded by a frame to illustrate a relationship among the items. An equation that may be used to fill in the frame is:

dₗ=[wf^{l-1}],

where dₗ in pixels of a border of level l, with l=1 . . . n, w is the width of the root level border, and f a factor that can be used to decrease the width for lower level borders. For the profile of the border, the following equation for a parabola may be used:

$${z}_{l} ( r ) = {a ( r + {s}_{l} )}^{2} + b ( r + {s}_{l} ) , with$$

$${s}_{l} = {\sum }_{i = 1}^{l - 1} {d}_{i} ,$$

where zₗ(r) is the height of the profile for level l, r is the distance from the outside for this level, and a and b are two coefficients that control shape of the parabola. The process may iteratively generate the layout for each of the polygons in the treemap 104 by going through blocks 1100 to 1112.

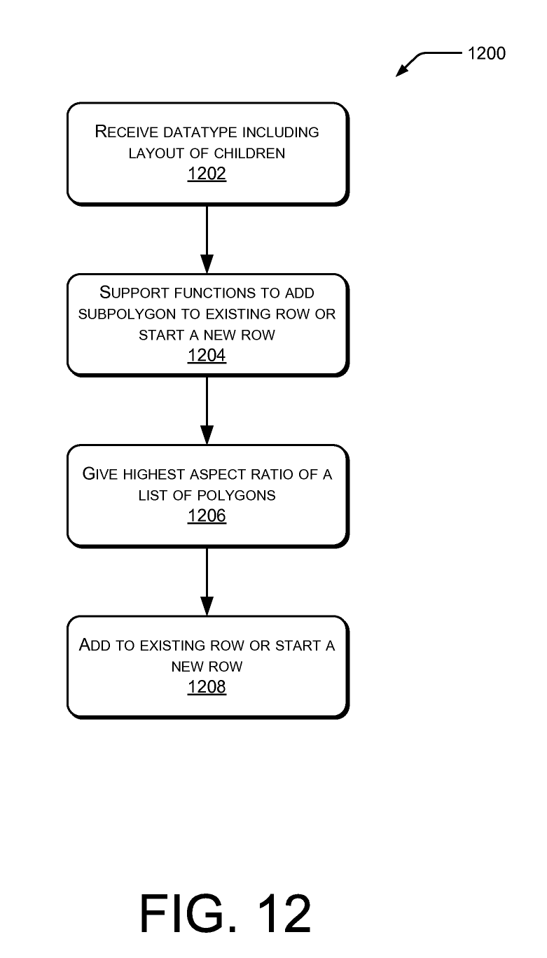

FIG. 12 is a flowchart showing an illustrative process 1200 of determining a layout of children for the treemap 104. The process lays out the polygons in horizontal or vertical rows by first determining whether to add a child polygon to a current existing row or that the current existing row is fixed, and to start a new row in the remaining sub-polygon. The decision is based on whether adding the child polygon to the current existing row improves the layout of the current existing row or not.

At block 1202, the process 1200 receives data type including layout of children.

At block 1204, the process 1200 supports functions to add a sub-polygon (i.e., the child) to the current row or to start a new row. Some of the functions supported are width that gives a length of a shortest side of the remaining sub-polygon in which the current existing row is placed and function layoutrow that adds a new row to the polygon. Other functions include representing concatenation of lists as +++, representing the list containing element x as [x], and representing an empty list as [ ]. The input is a list of real numbers, representing the areas of the children to be laid out. The list row contains the polygons that are currently being laid out.

At block 1206, the process 1200 uses a function “worst” to give a highest aspect ratio of a list of polygons. This is based on given the length of the side along which they are to be laid out.

An example of an algorithm to determine the layout for the children may be used. The example algorithm is shown below as:

Procedure squarify(list of real children, list of real row, real w begin

```
real c = head(children);
if worst(row, w) ≦ worst(row++[c], w) then
    squarify(tail(children), row++[c], w)
else
      layoutrow(row);
      squarify(children[ ], width( ));
    if
end.
```

Based on the list of areas R being given and letting s be their total sum, the function worst may be represented by:

$$worst ( R , w ) = {max}_{r ∈ R} ( max ( {w}^{2} r / {s}^{2} , {s}^{2} / ( {w}^{2} r ) ) ) .$$

As one term is increasing in r and the other term is decreasing, this is equal to:

max(w²r⁺/(s²),s²/(w²r⁻))

where r⁺ and r⁻ are the maximum and minimum of R. This represents the current maximum and minimum of the row that is being laid out.

At block 1208, the process 1200 determines whether to add the child to the current existing row or to start a new row with the child.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A user interface for use in conjunction with a treemap that represents property nodes of large-scale data as polygons, the user interface comprising:
one or more navigation buttons configured to receive a selection of a color or a pattern for a background of a polygon, where the color or the pattern in the background is indicates a first property of the nodes;
the one or more navigation buttons being further configured to receive another selection of another color or another pattern for a bar, where the another color or the another pattern in the bar indicates a second property of the nodes; and
the one or more navigation buttons being further configured to receive a selection of a name of the first property to be placed on top of the selected color or pattern for the bar that is placed over the selected color or pattern for the background of the polygon in presenting the visualization of the treemap.

2. The user interface of claim 1, further comprising:
the one or more navigation buttons to select hierarchical data represented by polygons at any level, to select for viewing in predefined or custom views; and
a custom overview pane to display the selected hierarchical data represented by the polygons at any level in the predefined or the custom views.

3. The user interface of claim 1, further comprising the one or more navigation buttons receiving an additional selection of an additional color or an additional pattern for an additional bar to visualize a third property of the nodes.

4. The user interface of claim 1, further comprising a current path descriptor to illustrate a path from a root node to a selected node, wherein the selected node has been selected for viewing from the treemap.

5. The user interface of claim 1, further comprising a trending navigation button to enable visualizing trending of a property associated with temporal information for a period of time.

6. The user interface of claim 1, further comprising a search navigation button to search content information of the polygons in the treemap based on a query input.

7. The user interface of claim 1, further comprising:
a search navigation feature to receive a query for a search on a search function;
the search navigation feature to present a numerical order assigned to each search result; and
the search navigation feature to display a number that corresponds to the numerical order, the number is placed on a polygon associated with the results of the search.

8. The user interface of claim 1, further comprising:
a level-up feature to view high level polygons, including parent nodes in a current view of the treemap; and
a level-down feature to view low level polygons, including children nodes in the current view.

9. A system comprising:
a treemap generator configured to:
receive input of large-scale data into a treemap, the large-scale data having multiple attributes, wherein nodes are represented by polygons in the treemap;
identify a size of polygons for the large-scale data, a value of a primary attribute of a parent node is equal to a summary of a value of all of its children nodes determines the size;
provide a visualization of the treemap based on the identified size of the polygons; and
a data visualization service configured to provide a trending function to enable visualizing trending of an attribute of a node, wherein the node is associated with temporal information over a period of time.

10. The system of claim 9, the treemap generator further configured to: apply a recursive process to determine layout of nodes in the treemap based on displaying polygons having a threshold value of about a width and about a height greater than ten pixels, and displaying a child node and its siblings if the nodes satisfy a criteria for the threshold value.

11. The system of claim 9, further comprising:
servers calculating a layout of the treemap;
receiving commands for the layout of the treemap;
presenting a corresponding layout of the treemap in response to the commands by providing a partial-tree based cache to reduce an amount of data being transferred from the servers.

12. The system of claim 9, wherein the input of large-scale data is received by embedding a treemap control into a web application and transmitting the large-scale data over the web application.

13. The system of claim 9, further comprising a data visualization component to determine a number of user-defined views that may occur simultaneously for multiple users.

14. The system of claim 9, further comprising a treemap interface component to provide a visualization of properties of nodes in a treemap, by receiving input selection of a color or a pattern for a background or a bar of a polygon, where the color or the pattern is being used to represent another property of the nodes in the treemap.

15. One or more computer-readable storage media encoded with instructions that, when executed by a processor, perform acts comprising:
providing a visualization of large-scale data in a treemap, the large-scale data having multiple attributes, wherein nodes are represented by polygons in the treemap;
receiving a query for a search of the polygons using a search function;
presenting search results in response to the query;
assigning a numerical order to each search result in a list; and
displaying a number that corresponds to the numerical order on a polygon associated with the search result.

16. The one or more computer-readable storage media of claim 15, further comprising:
enabling movement from an overview pane in the treemap to a selected portion of polygons in the treemap; and
enabling movement from one level in a hierarchical order in the treemap to a another level in the hierarchical order in the treemap.

17. The one or more computer-readable storage media of claim 15, further comprises identifying a size of the polygons for the large-scale data, the size being based on a value of a primary attribute of a parent node is equal to a summary of an attribute value of all of its children nodes.

18. The one or more computer-readable storage media of claim 15, further comprising:
receiving a selection of a color or a pattern for a background of a polygon, where the color or the pattern in the background is being used to visualize a first attribute of the nodes; and
further receiving another selection of another color or another pattern for a bar, where the another color or the another pattern in the bar is being used to visualize a second attribute of the nodes.

19. The one or more computer-readable storage media of claim 15, further comprising:
displaying a path of a selected node from a root node to the selected node in the treemap; and
providing access to any nodes in the path by clicking on any nodes of the path.

20. The one or more computer-readable storage media of claim 15, wherein the large-scale data is received from at least one of Extensible Markup Language (XML) files, through a custom data adapter, through a web service, or embedded control into a web application through a data server.
